(19) United States
(12) Patent Application Publication
(10) Pub. No.: US 2025/0307214 A1
(43) Pub. Date: Oct. 2, 2025

(54) DISTRIBUTED STORAGE SYSTEM JOURNAL ON A SINGLE MEMORY PAGE

(71) Applicant: NUTANIX, INC., San Jose, CA (US)

(72) Inventors: Rohit JAIN, Cupertino, CA (US); Tabrez Parvez MEMON, Campbell, CA (US); Harshit AGARWAL, Fremont, CA (US); Ashwin THENNARAMVAKKAYIL, Bengaluru (IN)

(21) Appl. No.: 19/082,057

(22) Filed: Mar. 17, 2025

(30) Foreign Application Priority Data
Apr. 1, 2024 (IN) 202441027085

(51) Int. Cl. G06F 16/18; G06F 16/17

(52) U.S. Cl. CPC G06F 16/1815; G06F 16/1727; G06F 16/1865

(57) ABSTRACT

Techniques for storing metadata include receiving a write operation directed to at least one data block in a first location on a storage device, and storing write data associated with the write operation in a key-value store associated with the first location of the storage device. The techniques also include storing a first pending transaction record associated with the write operation in a pending transaction journal, wherein the pending transaction journal comprises a single storage page that further includes all other pending transaction records associated with other write operations associated with the storage device.

### CROSS-REFERENCE TO RELATED APPLICATIONS

This application claims priority to India Provisional Application No. 202441027085, titled “DISTRIBUTED STORAGE SYSTEM JOURNAL ON A SINGLE MEMORY PAGE,” filed Apr. 1, 2024, the subject matter of which is incorporated by reference herein.

### BACKGROUND

### Field of the Various Embodiments

Embodiments of the present invention relate generally to database management technologies, and more specifically, to a distributed storage system journal on a single memory page.

### Description of the Related Art

In networked storage systems, it is common to store data in a set of blocks distributed across multiple disk drives. Such a set of blocks distributed across multiple disk drives is referred to herein as an extent group or, more simply, an egroup. In some implementations, a networked storage system utilizes a write ahead log (WAL) stored on the disk to record the transactions that are happening on the egroups stored on that disk. The write ahead log is also referred to herein as a journal. The WAL is an append-only log and keeps on growing as more transactions are processed.

When the WAL grows beyond a certain threshold size, a checkpoint operation is performed to generate a new file where the end/current state of every extent group is captured in the new file. The previous files (known as delta files) are discarded. The new transactions from this point forward are captured in the newly opened delta files and the WAL. The checkpoint operation reduces the size of the WAL files because the checkpointed WAL only captures the final state. When there is a crash, the WAL is replayed from the last checkpoint and all the delta files after the last checkpoint and all the transactions that were ongoing and finalized are recovered in the memory. The in-memory state serves as the basis for performing future transactions and is updated with every transaction.

One problem with this approach for maintaining write ahead logs is that the in-memory footprint and the WAL footprint on disk keeps growing as the number of extent groups similarly grows on the disk. As a result, the performance of the networked storage system can suffer over time due to processing a WAL file that is ever increasing in size. Another problem with this approach is that the recovery time after a crash is also proportional to the amount of data stored on the disk drives and, correspondingly, the size of the WAL files associated with the stored data.

As the foregoing indicates, what is needed in the art is a more efficient way to maintain a journal associated with data stored on a networked storage system.

### SUMMARY

The disclosed embodiments describe techniques for maintaining a journal for a distributed storage system on a single memory page. Storing only basic information about pending transactions in a journal comprising a single memory page allows the journal size to be constant while the memory storage requirement increases as more data is stored in the extent groups. Similarly, crash recovery time remains low (because of the small journal size) even as the amount of stored data increases.

In various embodiments, one or more non-transitory computer-readable media store program instructions that, when executed by one or more processors of a computing device, cause the one or more processors to perform a method comprising receiving a write operation directed to at least one data block in a first location of a storage device; storing write data associated with the write operation in a key-value store associated with the first location of the storage device; and storing a first pending transaction record associated with the write operation in a pending transaction journal, wherein the pending transaction journal comprises a single storage page that further includes all other pending transaction records associated with other write operations associated with the storage device.

Further embodiments provide, among other things, methods and systems for implementing one or more aspects of the disclosed techniques.

At least one technical advantage of the disclosed techniques relative to prior art is that, with the disclosed techniques, a journal of the outstanding transactions, or tentative updates, on a storage device is captured in a single block. Further, a listing of tentative updates is maintained in the single block, which allows the system to keep the tentative updates small relative to using WALs. The disclosed techniques further allow the updating of the journal via an atomic read-modify-write operation of the single block, which avoids the drawbacks associated with more complex non-atomic operations when updating a conventional WAL. In addition, the disclosed techniques facilitate reduction of metadata format related transformations and eliminate checkpointing, further reducing overhead previously related to maintaining a WAL. The reduced journal size leads to reduced recovery time after a storage device crash, during which the journal is processed in order to restore the system after the crash. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIGS. 1A-1D are block diagrams illustrating virtualization system architectures configured to implement one or more aspects of the present embodiments.

FIG. 2 is a block diagram illustrating a computing environment configured to implement one or more aspects of the present embodiments.

FIG. 3 is a data flow illustrating how the data management engine stores information pertaining to a write transaction according to one or more aspects of the present embodiments.

FIG. 4 illustrates the structure of a journal page, or a pending transaction journal, according to one or more aspects of the present embodiments.

FIG. 5 is a flow diagram of method steps for a primary storage node processing a write transaction, according to one or more aspects of the present embodiments.

FIG. 6 is a flow diagram of method steps for a primary storage node processing a write transaction, according to one or more aspects of the present embodiments.

FIG. 7 is a flow diagram of method steps for a secondary storage node processing a write transaction, according to one or more aspects of the present embodiments.

FIG. 8 is a flow diagram of method steps for operation of a data management engine utilizing the number of prefetched blocks field, number of free blocks field, and block map from journal page, according to one or more aspects of the present embodiments.

### DETAILED DESCRIPTION

In the following description, various concepts and examples are disclosed that provide more effective techniques for processing metadata associated with transactions in a storage cluster. The numerous specific details set forth will provide artisans with a more thorough understanding of the various embodiments. However, it will be apparent to one skilled in the art that the inventive concepts can be practiced without one or more of these specific details.

### Exemplary Virtualization System Architectures

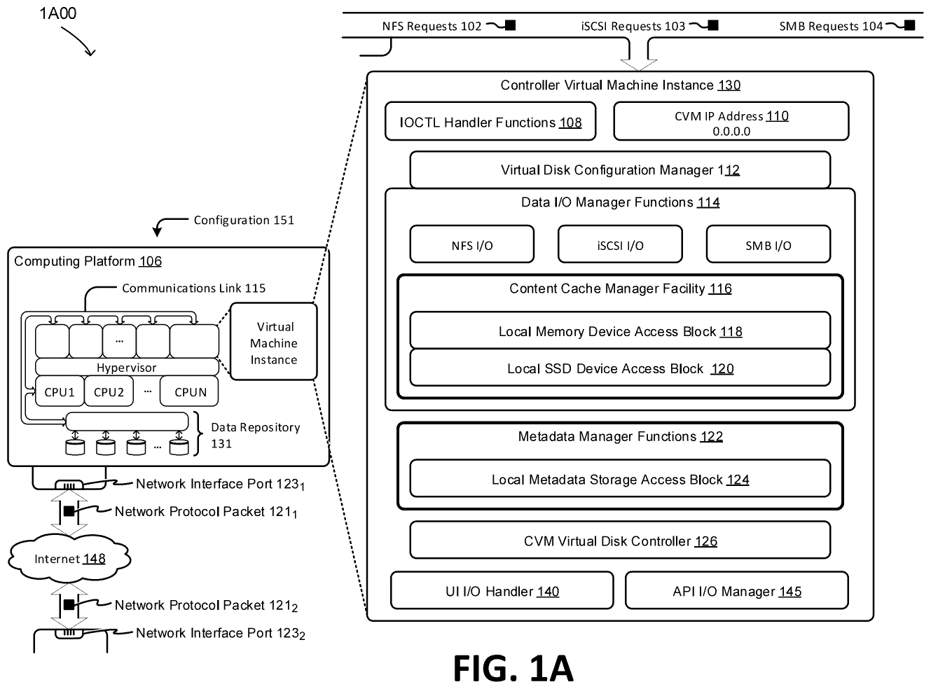

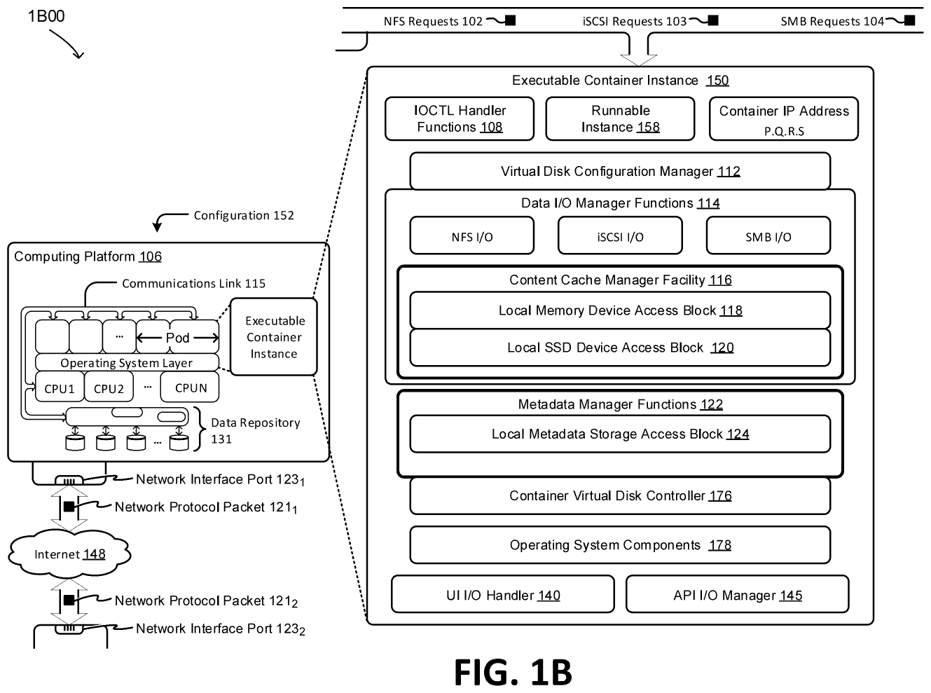

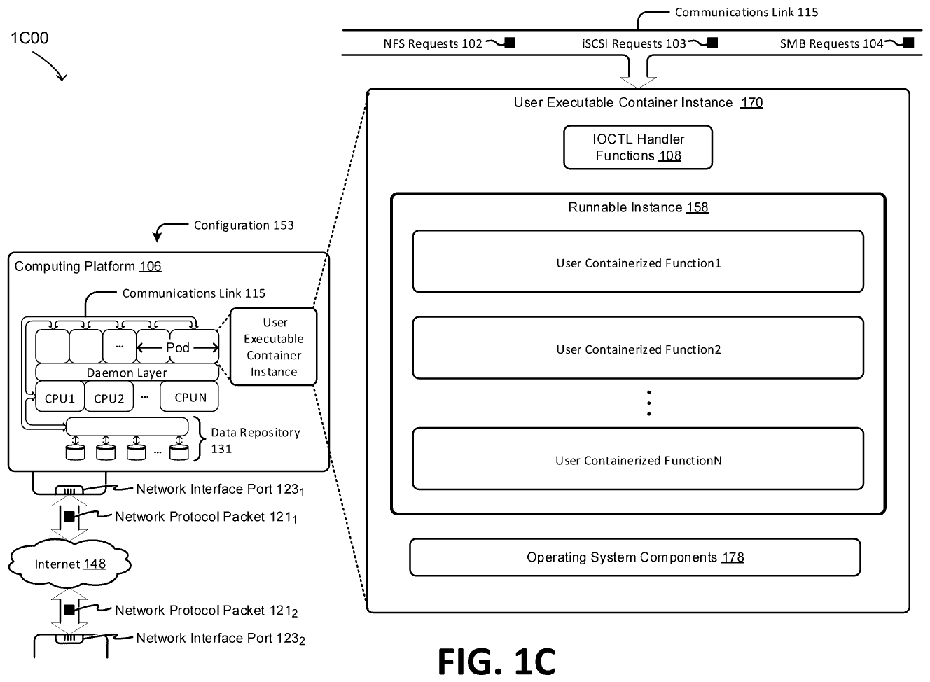

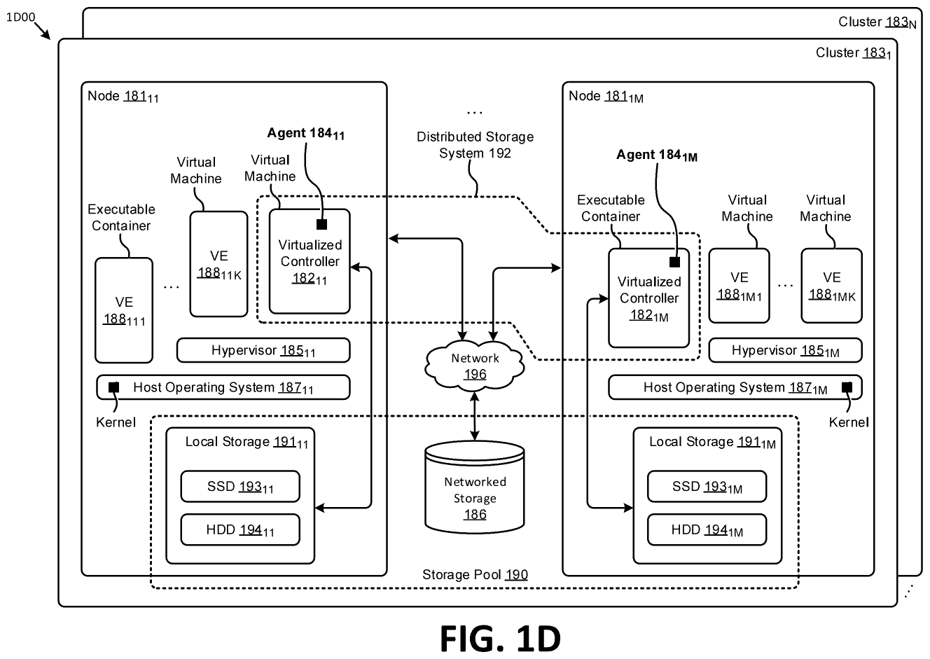

According to some embodiments, all or portions of any of the disclosed techniques can be partitioned into one or more modules and instances within, or as, or in conjunction with a virtualized controller in a virtual computing environment. Some example instances within various virtual computing environments are shown and discussed in further detail in FIGS. 1A-1D. Consistent with these embodiments, a virtualized controller includes a collection of software instructions that serve to abstract details of underlying hardware or software components from one or more higher-level processing entities. In some embodiments, a virtualized controller can be implemented as a virtual machine, as an executable container, or within a layer (e.g., such as a layer in a hypervisor). Consistent with these embodiments, distributed systems include collections of interconnected components that are designed for, or dedicated to, storage operations as well as being designed for, or dedicated to, computing and/or networking operations.

In some embodiments, interconnected components in a distributed system can operate cooperatively to achieve a particular objective such as to provide high-performance computing, high-performance networking capabilities, and/or high-performance storage and/or high-capacity storage capabilities. For example, a first set of components of a distributed computing system can coordinate to efficiently use a set of computational or compute resources, while a second set of components of the same distributed computing system can coordinate to efficiently use the same or a different set of data storage facilities.

In some embodiments, a hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

In some embodiments, physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

FIG. 1A is a block diagram illustrating virtualization system architecture 1A00 configured to implement one or more aspects of the present embodiments. As shown in FIG. 1A, virtualization system architecture 1A00 includes a collection of interconnected components, including a controller virtual machine (CVM) instance 130 in a configuration 151. Configuration 151 includes a computing platform 106 that supports virtual machine instances that are deployed as user virtual machines, or controller virtual machines or both. Such virtual machines interface with a hypervisor (as shown). In some examples, virtual machines can include processing of storage I/O (input/output or IO) as received from any or every source within the computing platform. An example implementation of such a virtual machine that processes storage I/O is depicted as CVM instance 130.

In this and other configurations, a CVM instance receives block I/O storage requests as network file system (NFS) requests in the form of NFS requests 102, internet small computer storage interface (iSCSI) block IO requests in the form of iSCSI requests 103, Samba file system (SMB) requests in the form of SMB requests 104, and/or the like. The CVM instance publishes and responds to an internet protocol (IP) address (e.g., CVM IP address 110). Various forms of input and output can be handled by one or more IO control handler functions (e.g., IOCTL handler functions 108) that interface to other functions such as data IO manager functions 114 and/or metadata manager functions 122. As shown, the data IO manager functions can include communication with virtual disk configuration manager 112 and/or can include direct or indirect communication with any of various block IO functions (e.g., NFS IO, iSCSI IO, SMB IO, etc.).

In addition to block IO functions, configuration 151 supports IO of any form (e.g., block IO, streaming IO, packet-based IO, HTTP traffic, etc.) through either or both of a user interface (UI) handler such as UI IO handler 140 and/or through any of a range of application programming interfaces (APIs), possibly through API IO manager 145.

Communications link 115 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), formatting of bit fields into fixed-length blocks or into variable length fields used to populate the payload, and/or the like. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry can be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

Computing platform 106 includes one or more computer readable media that is capable of providing instructions to a data processor for execution. In some examples, each of the computer readable media can take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random-access persistent memories (RAPMs) or optical or magnetic media drives such as paper tape or magnetic tape drives. Volatile media includes dynamic memory such as random-access memory (RAM). As shown, controller virtual machine instance 130 includes content cache manager facility 116 that accesses storage locations, possibly including local dynamic random-access memory (DRAM) (e.g., through local memory device access block 118) and/or possibly including accesses to local solid-state storage (e.g., through local SSD device access block 120).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of data repository 131, which in turn can be formatted into any one or more storage areas, and which can comprise parameterized storage accessible by a key (e.g., a filename, a table name, a block address, an offset address, etc.). Data repository 131 can store any forms of data and can comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 124. The data repository 131 can be configured using CVM virtual disk controller 126, which can in turn manage any number or any configuration of virtual disks.

Execution of a sequence of instructions to practice certain of the disclosed embodiments is performed by one or more instances of a software instruction processor, or a processing element such as a data processor, or such as a central processing unit (e.g., CPU1, CPU2, . . . , CPUN). According to certain embodiments of the disclosure, two or more instances of configuration 151 can be coupled by communications link 115 (e.g., backplane, LAN, PSTN, wired or wireless network, etc.) and each instance can perform respective portions of sequences of instructions as can be required to practice embodiments of the disclosure.

The shown computing platform 106 is interconnected to the Internet 148 through one or more network interface ports (e.g., network interface port 123₁ and network interface port 123₂). Configuration 151 can be addressed through one or more network interface ports using an IP address. Any operational element within computing platform 106 can perform sending and receiving operations using any of a range of network protocols, possibly including network protocols that send and receive packets (e.g., network protocol packet 121₁ and network protocol packet 121₂).

Computing platform 106 can transmit and receive messages that can be composed of configuration data and/or any other forms of data and/or instructions organized into a data structure (e.g., communications packets). In some cases, the data structure includes program instructions (e.g., application code) communicated through the Internet 148 and/or through any one or more instances of communications link 115. Received program instructions can be processed and/or executed by a CPU as it is received and/or program instructions can be stored in any volatile or non-volatile storage for later execution. Program instructions can be transmitted via an upload (e.g., an upload from an access device over the Internet 148 to computing platform 106). Further, program instructions and/or the results of executing program instructions can be delivered to a particular user via a download (e.g., a download from computing platform 106 over the Internet 148 to an access device).

Configuration 151 is merely one example configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (e.g., LAN or virtual LAN (VLAN)) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

In some embodiments, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to management of block stores. Various implementations of the data repository comprise storage media organized to hold a series of records and/or data structures.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT,” issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT,” issued on Oct. 1, 2013, which is hereby incorporated by reference in its entirety.

FIG. 1B depicts a block diagram illustrating another virtualization system architecture 1B00 configured to implement one or more aspects of the present embodiments. As shown in FIG. 1B, virtualization system architecture 1B00 includes a collection of interconnected components, including an executable container instance 150 in a configuration 152. Configuration 152 includes a computing platform 106 that supports an operating system layer (as shown) that performs addressing functions such as providing access to external requestors (e.g., user virtual machines or other processes) via an IP address (e.g., “P.Q.R.S”, as shown). Providing access to external requestors can include implementing all or portions of a protocol specification (e.g., “http:”) and possibly handling port-specific functions. In some embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node can communicate directly with storage devices on the second node.

The operating system layer can perform port forwarding to any executable container (e.g., executable container instance 150). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and can include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance can serve as an instance of an application container or as a controller executable container. Any executable container of any sort can be rooted in a directory system and can be configured to be accessed by file system commands (e.g., “Is” or “Is-a”, etc.). The executable container might optionally include operating system components 178, however such a separate set of operating system components need not be provided. As an alternative, an executable container can include runnable instance 158, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, container virtual disk controller 176. Such a container virtual disk controller can perform any of the functions that the aforementioned CVM virtual disk controller 126 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 1C is a block diagram illustrating virtualization system architecture 1C00 configured to implement one or more aspects of the present embodiments. As shown in FIG. 1C, virtualization system architecture 1C00 includes a collection of interconnected components, including a user executable container instance in configuration 153 that is further described as pertaining to user executable container instance 170. Configuration 153 includes a daemon layer (as shown) that performs certain functions of an operating system.

User executable container instance 170 comprises any number of user containerized functions (e.g., user containerized function1, user containerized function2, . . . , user containerized functionN). Such user containerized functions can execute autonomously or can be interfaced with or wrapped in a runnable object to create a runnable instance (e.g., runnable instance 158). In some cases, the shown operating system components 178 comprise portions of an operating system, which portions are interfaced with or included in the runnable instance and/or any user containerized functions. In some embodiments of a daemon-assisted containerized architecture, computing platform 106 might or might not host operating system components other than operating system components 178. More specifically, the shown daemon might or might not host operating system components other than operating system components 178 of user executable container instance 170.

In some embodiments, the virtualization system architecture 1A00, 1B00, and/or 1C00 can be used in any combination to implement a distributed platform that contains multiple servers and/or nodes that manage multiple tiers of storage where the tiers of storage might be formed using the shown data repository 131 and/or any forms of network accessible storage. As such, the multiple tiers of storage can include storage that is accessible over communications link 115. Such network accessible storage can include cloud storage or networked storage (e.g., a SAN or storage area network). Unlike prior approaches, the disclosed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In some embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

In some embodiments, any one or more of the aforementioned virtual disks can be structured from any one or more of the storage devices in the storage pool. In some embodiments, a virtual disk is a storage abstraction that is exposed by a controller virtual machine or container to be used by another virtual machine or container. In some embodiments, the virtual disk is exposed by operation of a storage protocol such as iSCSI or NFS or SMB. In some embodiments, a virtual disk is mountable. In some embodiments, a virtual disk is mounted as a virtual storage device.

In some embodiments, some or all of the servers or nodes run virtualization software. Such virtualization software might include a hypervisor (e.g., as shown in configuration 151) to manage the interactions between the underlying hardware and user virtual machines or containers that run client software.

Distinct from user virtual machines or user executable containers, a special controller virtual machine (e.g., as depicted by controller virtual machine instance 130) or as a special controller executable container is used to manage certain storage and I/O activities. Such a special controller virtual machine is sometimes referred to as a controller executable container, a service virtual machine (SVM), a service executable container, or a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines—above the hypervisors—thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

FIG. 1D is a block diagram illustrating virtualization system architecture 1D00 configured to implement one or more aspects of the present embodiments. As shown in FIG. 1D, virtualization system architecture 1D00 includes a distributed virtualization system that includes multiple clusters (e.g., cluster 183₁, . . . , cluster 183_{N}) comprising multiple nodes that have multiple tiers of storage in a storage pool. Representative nodes (e.g., node 181₁₁, . . . , node 181_{1M}) and storage pool 190 associated with cluster 183₁ are shown. Each node can be associated with one server, multiple servers, or portions of a server. The nodes can be associated (e.g., logically and/or physically) with the clusters. As shown, the multiple tiers of storage include storage that is accessible through a network 196, such as a networked storage 186 (e.g., a storage area network or SAN, network attached storage or NAS, etc.). The multiple tiers of storage further include instances of local storage (e.g., local storage 191₁₁, . . . , local storage 191_{1M}). For example, the local storage can be within or directly attached to a server and/or appliance associated with the nodes. Such local storage can include solid state drives (SSD 193₁₁, . . . , SSD 193_{1M}), hard disk drives (HDD 194₁₁, . . . , HDD 194_{1M}), and/or other storage devices.

As shown, any of the nodes of the distributed virtualization system can implement one or more user virtualized entities (e.g., VE 188¹¹¹, . . . , VE 188^{11K}, . . . , VE 188^{1M1}, . . . , VE 188^{1MK}), such as virtual machines (VMs) and/or executable containers. The VMs can be characterized as software-based computing “machines” implemented in a container-based or hypervisor-assisted virtualization environment that emulates the underlying hardware resources (e.g., CPU, memory, etc.) of the nodes. For example, multiple VMs can operate on one physical machine (e.g., node host computer) running a single host operating system (e.g., host operating system 187¹¹, . . . , host operating system 187^{1M}), while the VMs run multiple applications on various respective guest operating systems. Such flexibility can be facilitated at least in part by a hypervisor (e.g., hypervisor 185¹¹, . . . , hypervisor 185^{1M}), which hypervisor is logically located between the various guest operating systems of the VMs and the host operating system of the physical infrastructure (e.g., node).

As an alternative, executable containers can be implemented at the nodes in an operating system-based virtualization environment or in a containerized virtualization environment. The executable containers are implemented at the nodes in an operating system virtualization environment or container virtualization environment. The executable containers can include groups of processes and/or resources (e.g., memory, CPU, disk, etc.) that are isolated from the node host computer and other containers. Such executable containers directly interface with the kernel of the host operating system (e.g., host operating system 187₁₁, . . . , host operating system 187_{1M}) without, in most cases, a hypervisor layer. This lightweight implementation can facilitate efficient distribution of certain software components, such as applications or services (e.g., micro-services). Any node of a distributed virtualization system can implement both a hypervisor-assisted virtualization environment and a container virtualization environment for various purposes. Also, any node of a distributed virtualization system can implement any one or more types of the foregoing virtualized controllers so as to facilitate access to storage pool 190 by the VMs and/or the executable containers.

Multiple instances of such virtualized controllers can coordinate within a cluster to form the distributed storage system 192 which can, among other operations, manage the storage pool 190. This architecture further facilitates efficient scaling in multiple dimensions (e.g., in a dimension of computing power, in a dimension of storage space, in a dimension of network bandwidth, etc.).

In some embodiments, a particularly configured instance of a virtual machine at a given node can be used as a virtualized controller in a hypervisor-assisted virtualization environment to manage storage and I/O (input/output or IO) activities of any number or form of virtualized entities. For example, the virtualized entities at node 181₁₁ can interface with a controller virtual machine (e.g., virtualized controller 18211) through hypervisor 185₁₁ to access data of storage pool 190. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 192. For example, a hypervisor at one node in the distributed storage system 192 might correspond to software from a first vendor, and a hypervisor at another node in the distributed storage system 192 might correspond to a second software vendor. As another virtualized controller implementation example, executable containers can be used to implement a virtualized controller (e.g., virtualized controller 182_{1M}) in an operating system virtualization environment at a given node. In this case, for example, the virtualized entities at node 181_{1M} can access the storage pool 190 by interfacing with a controller container (e.g., virtualized controller 182_{1M}) through hypervisor 185_{1M} and/or the kernel of host operating system 187_{1M}.

In some embodiments, one or more instances of an agent can be implemented in the distributed storage system 192 to facilitate the herein disclosed techniques. Specifically, agent 184₁₁ can be implemented in the virtualized controller 182₁₁, and agent 184_{1M} can be implemented in the virtualized controller 182_{1M}. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or the agents.

### Storage Nodes in a Storage Cluster

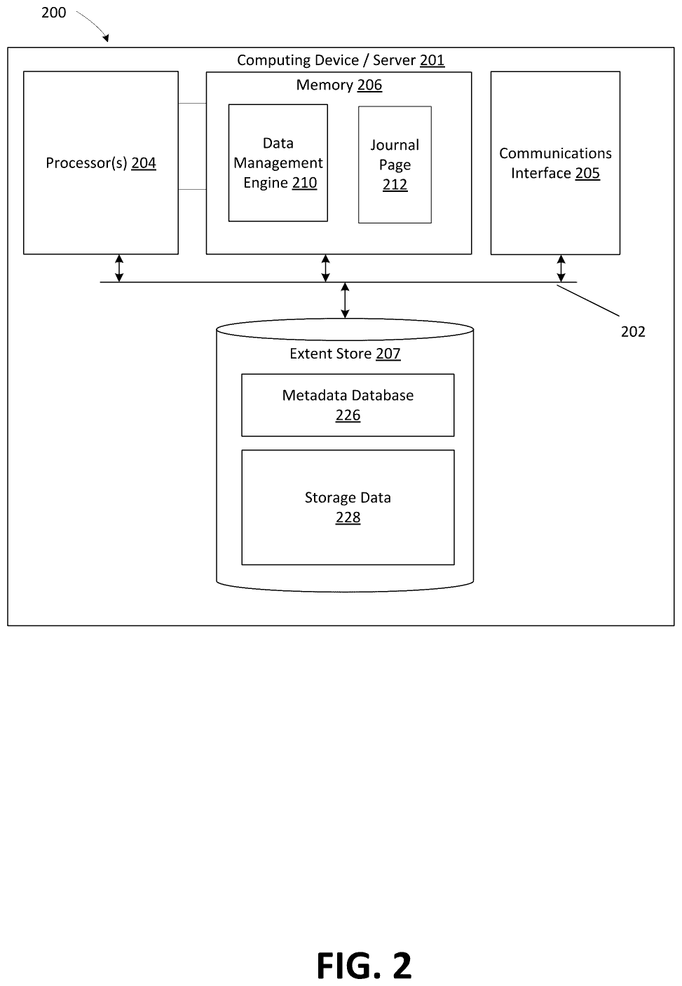

FIG. 2 is a block diagram illustrating a computing environment 200 configured to implement one or more aspects of the present embodiments. As shown, the computing environment 200 includes, without limitation, a computing device or server 201. The server 201 includes, without limitation, a bus 202, one or more processors 204, a communications interface 205, a memory 206, and an extent store 207. Memory 206 includes, without limitation, a data management engine 210 and a journal page 212. The extent store 207 includes, without limitation, a metadata database 226 and storage data 228. While journal page 212 is depicted in the memory 206, the journal page 212 can also be stored in the extent store 207 or other disk associated with server 201. The journal page 212 is also referred to herein as a pending transaction journal 212. The components of the computing environment 200 of FIG. 2 can be included in any of the virtualization system architectures shown in FIGS. 1A-1D.

Server 201 can be deployed as one of multiple servers 201 in a storage cluster. The servers 201 in the storage cluster are also referred to as storage nodes. A storage cluster provides virtual disk capabilities to other workloads, such as virtual machines that are executed in the virtualization system architectures shown in FIGS. 1A-1D. By utilizing multiple storage nodes, a storage cluster can replicate data among multiple storage nodes to provide data redundancy and availability.

The bus 202 interconnects subsystems and devices within server 201, such as the one or more processors 204, the communications interface 205, memory 206, and extent store 207. The computing environment 200 described herein is illustrative and any other technically feasible configurations fall within the scope of the present disclosure. Further, in the context of this disclosure, the computing elements shown in the computing environment 200 can correspond to a physical computing system (e.g., a system in a data center) or can include a virtual computing instance.

The one or more processors 204 include any suitable processors implemented as a central processing unit (CPU), a graphics processing unit (GPU), an application-specific integrated circuit (ASIC), a field programmable gate array (FPGA), an artificial intelligence (AI) accelerator, any other type of processor, or a combination of different processors, such as a CPU configured to operate in conjunction with a GPU. In general, one or more processors 204 can be any technically feasible hardware unit capable of processing data and/or executing software applications.

Memory 206 includes a random-access memory (RAM) module, a flash memory unit, and/or any other type of memory unit or combination thereof. The one or more processors 204 are configured to read data from and write data to memory 206. Memory 206 includes various software programs that include one or more instructions that can be executed by the one or more processors 204 and application data associated with said software programs.

Data management engine 210 includes executable instructions such as a program or application that performs data management operations for the extent store 207. Data management operations include receiving and processing read and/or write transactions from an application utilizing the storage cluster, servicing read and/or write transactions, garbage collection, lifecycle management, and other actions. For example, a virtual machine stores data in a virtual disk that is provided by a storage cluster. The storage cluster writes the data from the virtual machine onto one or more storage nodes in the storage cluster. When the virtual machine reads the data from the virtual disk, the storage cluster retrieves the data from one or more of the storage nodes. Garbage collection includes identifying and reclaiming data areas within a storage device 222 when the data stored in that location is no longer needed or utilized according to data management rules. Lifecyle management includes moving data from one storage device 222 to another storage device 222 according to data management rules. For example, lifecycle management can include moving data that is infrequently used from an SSD to an HDD, moving data that is frequently used from an HDD to an SDD, and other data movement decisions. Virtual machines or other workloads that are provided access to virtual disks by a storage cluster powered by data management engine 210 need not have knowledge of lifecycle management, garbage collection, or other data management processes that enable storage of data on behalf of the workloads among storage nodes of the storage cluster.

Data management engine 210 stores various metadata corresponding to data stored in the extent store 207. Data management engine 210 stores a pending transaction journal, or a journal page 212. The journal page 212 can be stored in memory 206, in the extent store 207 or on another disk associated with server 201. The journal page 212 comprises a single storage page that includes all of the pending transaction records associated with write operations associated with the extent store 207, or a disk of the server 201. Pending transactions are transactions that have not yet been committed to the extent store 207. The journal page 212 is equivalent in size to a size of a single block on the disk of server 201 (e.g., a 4 kilobyte block), which makes updating the journal page 212 efficient because it can be done in a single write operation. For example, a record in the journal page 212 is updated by data management engine 210 using an indivisible read-modify-write memory transaction.

The records in the journal page 212 represent pending transactions that are in the process of being stored to the storage cluster by one or more storage nodes. For example, data management engine 210 receives a write transaction that includes data to be written to the extent store 207. If the server 201 on which data management engine 210 is executing represents the primary storage node on which the data is being stored, information about the write transaction is stored in the journal page 212 and the write transaction is forwarded to one or more secondary storage nodes in the storage cluster that will also store replicas of the data. The information about the write transaction that is stored in the journal page 212 is also referred to as a tentative update entry. A tentative update entry in the journal page 212 includes an identifier of an extent group in the extent store 207 to which data is being written, an extent index representing an extent within the extent group to which data is being written, and a logical transaction sequence identifier that represents a monotonically increasing identifier that identifies the write transaction.

If the server 201 represents a primary storage node, the journal page 212 also stores information about a write transaction until data management engine 210 receives confirmation from secondary storage nodes that the replicas associate with the write transaction have been successfully committed by all the secondary storage nodes. Then, data management engine 210, as primary storage node, commits the write transaction to the extent store 207 on the server 201. Until a write transaction is committed by data management engine 210 on a given server 201, a corresponding tentative update entry is maintained in the journal page 212. The tentative update entry is maintained in the journal page 212 so that, in the event of a crash of one of the storage nodes, the data management engine 210 can determine whether to roll forward or roll back a transaction that has not yet been committed to the extent store 207. When a given write transaction has been committed to the extent store 207 by data management engine 210, data management engine 210 removes the corresponding tentative update entry from extent store 207.

If a given server 201 is operating as a secondary storage node for a write transaction, data management engine 210 receives the write transaction corresponding to a replica from another server 201 operating as the primary storage node. Data management engine 210 stores a tentative update entry in its respective journal page 212 and writes the data associated with the write transaction to its respective extent store 207. Upon committing the write transaction to the extent store 207, data management engine 210 confirms to the primary storage node that the transaction was committed and removes the tentative update entry from the journal page 212.

Data management engine 210 also prefetches blocks of storage from storage data 228 for allocation to write transactions. Data management engine 210 prefetches blocks from storage data 228 for subsequent write transactions to reduce the number of block allocations, which is computationally expensive. Additionally, prefetching blocks causes the writes to be performed in a sequential manner within storage data 228 even though the write transaction might be associated with different extents. Performing writes in a sequential manner can be more efficient than non-sequential writes based on the characteristics of disks utilized to house storage data 228. Accordingly, the journal page 212 stores information about the prefetched blocks, such as a quantity of prefetched blocks, so that data management engine 210 can prefetch additional blocks when the quantity of prefetched blocks reduces below a configurable threshold due to write transactions performed by data management engine 210.

Journal page 212 also stores information about the blocks that are freed due to overwrites caused by write transactions. Data management engine 210 maintains allocations of blocks that are freed due to overwrites, or free blocks, rather than deallocating or returning these blocks to extent store 207 so that the free blocks can be reused by a later write transaction without the computational overhead of deallocation and a subsequent allocation. Accordingly, the journal page 212 stores information about the quantity of free blocks that are allocated to data management engine 210. In some instances, the number of free blocks could decrease, remain constant, or increase depending upon the write transaction. For example, a write transaction can delete a block that previously stored data, which causes the number of free blocks to increase or be incremented.

Journal page 212 also stores a block map that identifies which blocks within storage data 228 are free and which blocks are used to store data. In some embodiments, the block map specifies an extent identifier or extent group identifier that is occupying the respective blocks. The block map allows data management engine 210 to determine which blocks within storage data 228 are free when performing write transactions to extent store 207. When data management engine 210 writes data to storage data 228 in the extent store 207, the data management engine 210 updates the block map to reflect the blocks that are either written or freed as a result of the write transaction.

When data management engine 210 commits a transaction to extent store 207, metadata related to the transaction is also stored to metadata database 226 in the extent store 207. Metadata database 226 can be implemented as a key-value store that is stored on the disk associated with the extent store 207. The metadata in the metadata database 226 includes an extent group associated with the data, a physical location on the disk on which the data is stored, a logical address associated with the data, and other information that is utilized for garbage collection, lifecycle management, and other purposes. In one embodiment, the metadata database 226 is structured as a b-tree data structure, where each node in the b-tree is a four-kilobyte node that describes a one-megabyte range of blocks in a storage volume. In one example, a node in the b-tree data structure includes a listing of the block identifiers of a one-megabyte range of blocks in the storage volume along with metadata so that a transaction can be rolled forward or backward. In other words, each node in the b-tree includes metadata for a respective location on the disk of the server 201. In some implementations, each node in the b-tree contains the metadata for a single extent of storage in a storage cluster. Additionally, each b-tree node can be sized to occupy a single block of storage on the disk, such as a four-kilobyte node. By sizing the b-tree node thusly, writing a b-tree node to disk is an atomic operation by virtue of the node being contained within a single block on disk.

In one implementation, when a node of the b-tree is updated, a zero-copy ready-modify-write performance is achieved by using a pointer to the metadata being written in the data buffer of the b-tree node containing the metadata. The data buffer is pinned in memory until the write transaction is completed. All updates to the metadata are made directly in the pinned buffer of the b-tree node instead of making a copy of the buffer when reading and writing metadata to the node.

Extent store 207 includes, without limitation, non-volatile storage for applications and data, and may include one or more fixed or removable disk drives, HDDs, SSD, NVMes, vDisks, flash memory devices, and/or other magnetic, optical, and/or solid-state storage devices. The extent store 207 can include physical storage devices of a storage cluster. The physical storage devices include, without limitation, non-volatile storage for applications and data, and may include one or more fixed or removable disk drives, HDDs, SSD, NVMes, vDisks, flash memory devices, and/or other magnetic, optical, and/or solid-state storage devices. Extent store 207 stores data that is housed in the storage cluster and assigned to storage in the server 201 operating as a storage node in the cluster. Metadata database 226 includes metadata associated with data stored in extent store 207. Storage data 228 includes the data stored by the server 201. The data stored by the server is also referred to as extents. An extent is a unique piece of data stored by the server 201. An extent can be referenced by or accessed by one or more virtual disks that are stored in a storage cluster by virtual machines, for example. An extent group represents a group of extents that are, for example, stored in a single file. An extent and extent group can be assigned unique identifiers that are referenced by metadata stored in metadata database 226.

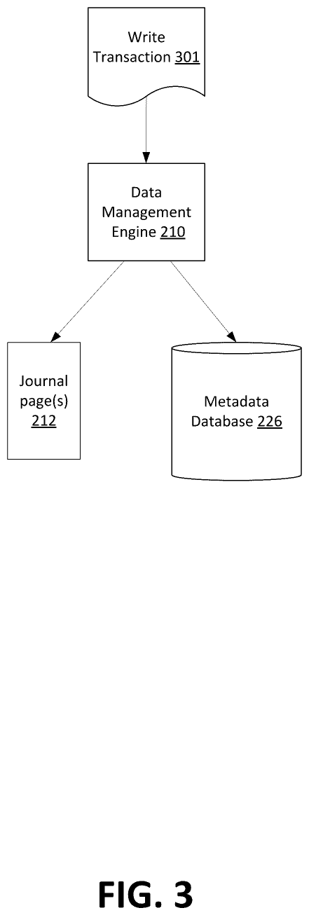

FIG. 3 is a data flow diagram illustrating how data management engine 210 stores metadata pertaining to a write transaction 301 according to an example of the disclosure. Data management engine 210 receives a write transaction 301 containing data to be written to extent store 207 of a server 201 on which data management engine 210 is executing. The data can correspond to a file that is being stored, edited, or deleted by an upstream system of a storage cluster, such as a virtual machine or other workload. In response to receiving the write transaction 301, the data management engine 210 stores a tentative update entry in the journal page 212. The tentative update entry corresponds to the write transaction 301. The tentative update entry is stored in the journal page 212 until the write transaction 301 is committed by the data management engine 210 to extent store 207. As noted above, if the server 201 is operating as a primary storage node for the write transaction 301, the data management engine 210 waits until the secondary storage nodes have committed the write transaction 301 before committing the write transaction 301 to the extent store 207. Once the write transaction 301 is committed to the extent store 207, data management engine 210 removes the tentative update entry corresponding to the write transaction 301 from the journal page 212. Metadata corresponding to the write transaction 301 is stored in the metadata database 226 if the write transaction 301 is committed to the 207.

If the write transaction 301 is rolled back by data management engine 210, the tentative update entry is removed from the journal page 212 by data management engine 210. The write transaction 301 is rolled back in the event that one or more of the primary storage node or the secondary storage nodes are unable to successfully process or commit the write transaction 301 to their respective extent stores 207.

### Pending Transaction Journal

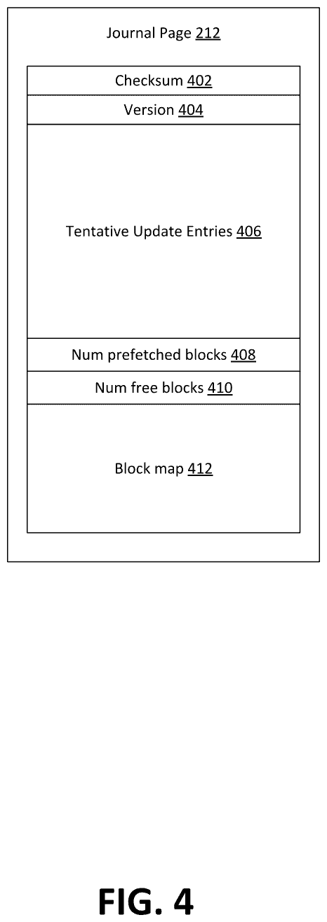

FIG. 4 illustrates the structure of a journal page 212, or a pending transaction journal, according to examples of the disclosure. As noted above, the journal page 212 is structured so that it is sized equivalently to the size of a block on the disk of server 201. The journal page 212 includes, without limitation, a checksum 402, a version field 404, tentative update entries 406, a number of prefetched blocks field 408, a number of free blocks field 410, and a block map 412. The checksum 402 comprises a 4-byte checksum for the journal page 212. The version field 404 identifies a version of the journal page 212. The checksum 402 and version field 404 are utilized for data integrity purposes in the event of a crash of the server 201 and data management engine 210 recovers the journal page 212 to identify write transactions 301 that were in progress as reflected in the journal page 212. The data management engine 210 determines whether to roll forward or roll backward transactions identified in the journal page 212 based upon whether the server 201 on which the data management engine 210 executes is operating as a primary storage node or secondary storage node for the respective transactions.

Tentative update entries 406, as described above, store information about write transactions 301 that are in-flight, or that are uncommitted to the extent store 207. In one implementation, the journal page 212 reserves approximately 2,872 bytes for the tentative update entries 406. A respective tentative update entry 406 includes, for example, an extent group identifier identifying an extent group being modified or written by a write transaction 301, an extent index identifying an extent within the extent group that is being updated, and a logical transaction sequence identifier that comprises an identifier of the write transaction 301. Data management engine 210 writes a tentative update entry 406 to the journal page 212 to indicate that there is a pending transaction on a particular extent within an extent group in the extent store 207. When a transaction is finalized, the tentative update entry 406 corresponding to the write transaction 301 is removed from journal page 212. In general, in the event of multiple transactions being simultaneously performed on the extent store 207, the journal page 212 can be updated using a single write of a block corresponding to the journal page 212.

The journal page 212 also stores an indication of the quantity of prefetched blocks in a number of prefetched blocks field 408. As noted above, data management engine 210 can prefetch additional blocks when the quantity of prefetched blocks reduces below a configurable threshold due to write transactions performed by data management engine 210. The number of prefetched blocks field 408 is approximately four bytes.

Journal page 212 also stores information about the blocks that are freed due to overwrites caused by write transactions in a number of free blocks field 410. Data management engine 210 maintains allocations of blocks that are freed due to overwrites, or free blocks, rather than deallocating or returning these blocks to extent store 207 so that the free blocks can be reused by a later write transaction without the computational overhead of deallocation and a subsequent allocation. Accordingly, the journal page 212 stores information about the quantity of free blocks that are allocated to data management engine 210 in this manner. The number of free blocks field 410 is approximately four bytes.

Journal page 212 also stores a block map that identifies which blocks within storage data 228 are free and which blocks are used to store data in a block map 412. In some embodiments, the block map specifies an extent identifier or extent group identifier that is occupying the respective blocks. The block map allows data management engine 210 to determine which blocks within storage data 228 are free when performing write transactions to extent store 207. The block map 412 is approximately 1208 bytes, which results in a total size of the journal page 212 of four kilobytes.

### Storage of Data to Primary and Secondary Storage Nodes

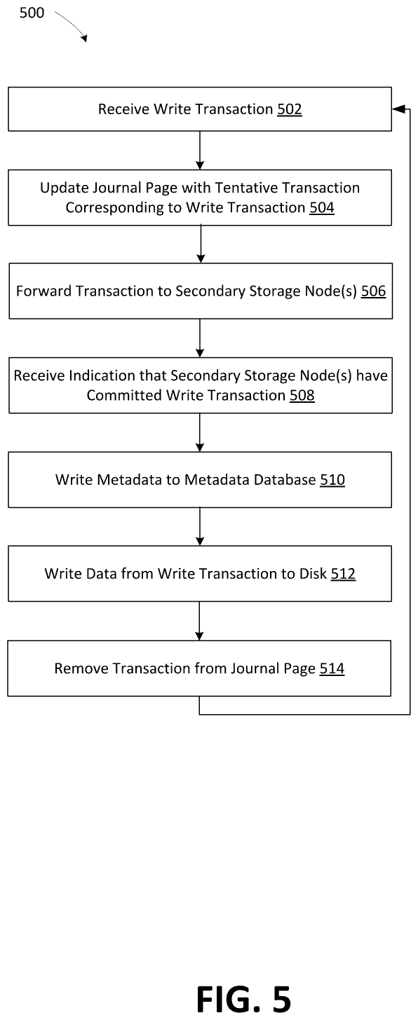

FIG. 5 is a flow diagram of method steps for a primary storage node processing a write transaction 301, according to various embodiments. Although the method steps are described in conjunction with the systems of FIGS. 1-4, persons of ordinary skill in the art will understand that any system configured to perform the method steps, in any order, is within the scope of the invention.

As shown, a method 500 begins at step 502, where the data management engine 210 running on a primary storage node receives a write transaction 301. The write transaction 301 is received from or on behalf of a virtual machine storing or editing data in a storage cluster. A server 201 executing data management engine 210 can operate as a primary storage node that forwards the write transaction 301 to secondary storage nodes in the storage cluster. The primary storage node also verifies that the secondary storage nodes have committed the write transaction 301 to their respective extent stores 207.

At step 504, data management engine 210 updates the journal page 212 with a tentative update entry 406 corresponding to the write transaction 301. The information in the tentative update entry 406 facilitates determination of whether a transaction has been committed in the event of a crash of the server 201 and recovery of the journal page 212 by data management engine 210.

At step 506, data management engine 210 forwards the write transaction 301 to one or more secondary storage nodes, which are servers 201 executing data management engine 210 operating as a secondary storage node. For example, data management engine 210 can use the one or more secondary storage nodes to store replicas of the data in the write transaction.

At step 508, data management engine 210 running on the primary storage node receives an indication that the one or more secondary storage nodes to which the write transaction 301 was forwarded have successfully committed the write transaction 301 to their respective extent stores 207. Unlike the primary storage node, the secondary storage nodes commit the write transaction 301 without waiting for another storage node to commit the write transaction 301.

At step 510, data management engine 210 writes metadata corresponding to the write transaction 301 to metadata database 226 in extent store 207. As noted above, the metadata corresponding to the write transaction 301 is stored in a b-tree data structure. At step 512, data management engine 210 commits the write transaction 301 to extent store 207 by writing the data from the write transaction 301 to storage data 228 in the extent store 207. Next, at step 514, data management engine 210 removes the tentative update entry 406 corresponding to the write transaction 301 from the journal page 212. The tentative update entry 406 is removed from the journal page 212 because the write transaction 301 has been committed to extent store 207 and is no longer a pending or tentative transaction.

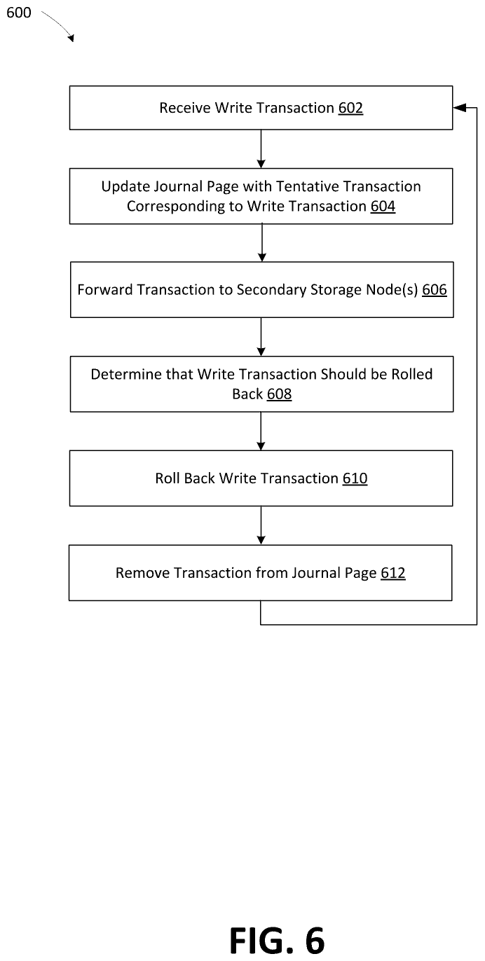

FIG. 6 is a flow diagram of method steps for a primary storage node processing a write transaction 301, according to various embodiments. Although the method steps are described in conjunction with the systems of FIGS. 1-4, persons of ordinary skill in the art will understand that any system configured to perform the method steps, in any order, is within the scope of the invention.

As shown, a method 600 begins at step 602, where the data management engine 210 running on a primary storage node receives a write transaction 301. The write transaction 301 is received from or on behalf of a virtual machine storing or editing data in a storage cluster. A server 201 executing data management engine 210 can operate as a primary storage node that forwards the write transaction 301 to secondary storage nodes in the storage cluster. The primary storage node also verifies that the secondary storage nodes have committed the write transaction 301 to their respective extent stores 207.

At step 604, data management engine 210 updates the journal page 212 with a tentative update entry 406 corresponding to the write transaction 301. The information in the tentative update entry 406 facilitates determination of whether a transaction has been committed in the event of a crash of the server 201 and recovery of the journal page 212 by data management engine 210.

At step 606, data management engine 210 forwards the write transaction 301 to one or more secondary storage nodes, which are servers 201 executing data management engine 210 operating as a secondary storage node. For example, data management engine 210 can use the one or more secondary storage nodes to store replicas of the data in the write transaction.

At step 608, data management engine 210 running on the primary storage node determines that the write transaction 301 should be rolled back. Data management engine 210 makes the determination based upon whether all of the secondary storage nodes to which data management engine 210 forwarded the write transaction 301 have responded with an indication that they have committed the write transaction 301 to their respective extent stores 207. For example, a secondary storage node could respond with an indication that the write transaction 301 was unsuccessfully committed or that the secondary storage node has rolled back the write transaction 301.

At step 610, data management engine 210 rolls back the write transaction 301. In one example, if the write transaction 301 was forwarded to more than one secondary storage node, data management engine 210 instructs the other secondary storage node to roll back the write transaction 301. Next, at step 612, data management engine 210 removes the tentative update entry 406 corresponding to the write transaction 301 from the journal page 212. The tentative update entry 406 is removed from the journal page 212 without committing the write transaction 301 to the extent store 207.

### Prefetching Storage Blocks and Block Map

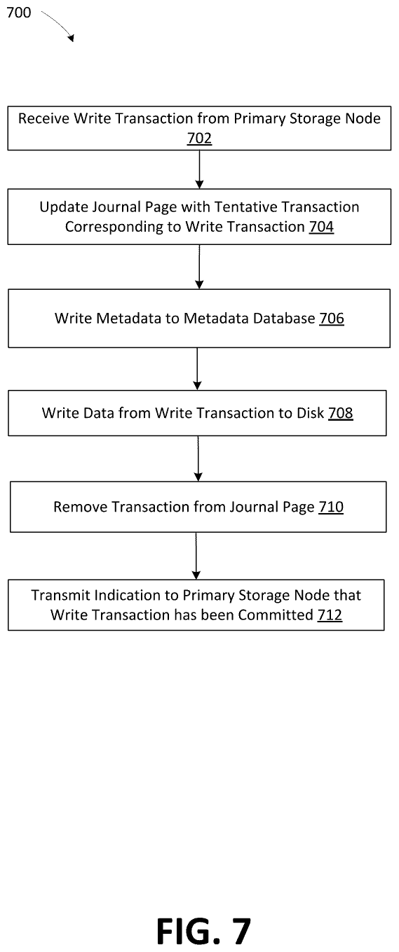

FIG. 7 is a flow diagram of method steps for a secondary storage node processing a write transaction 301, according to various embodiments. Although the method steps are described in conjunction with the systems of FIGS. 1-4, persons of ordinary skill in the art will understand that any system configured to perform the method steps, in any order, is within the scope of the invention.

As shown, a method 700 begins at step 702, where the data management engine 210 running on a primary storage node receives a write transaction 301. The write transaction 301 is received from a primary storage node, or another server 201 executing data management engine 210. At step 704, data management engine 210 updates the journal page 212 with a tentative update entry 406 corresponding to the write transaction 301. The information in the tentative update entry 406 facilitates determination of whether a transaction has been committed in the event of a crash of the server 201 and recovery of the journal page 212 by data management engine 210.

At step 706, the data management engine 210 writes metadata corresponding to the write transaction 301 to metadata database 226 in extent store 207. As noted above, the metadata corresponding to the write transaction 301 is stored in a b-tree data structure. At step 708, data management engine 210 commits the write transaction 301 to extent store 207 by writing the data from the write transaction 301 to storage data 228 in the extent store 207.

Next, at step 710, data management engine 210 removes the tentative update entry 406 corresponding to the write transaction 301 from the journal page 212. The tentative update entry 406 is removed from the journal page 212 because the write transaction 301 has been committed to extent store 207 and is no longer a pending or tentative transaction. At step 712, step 510 transmits an indication to the primary storage cluster that the write transaction 301 has been committed to the extent store 207 of the server 201.

### Prefetching Data Blocks for Write Transactions

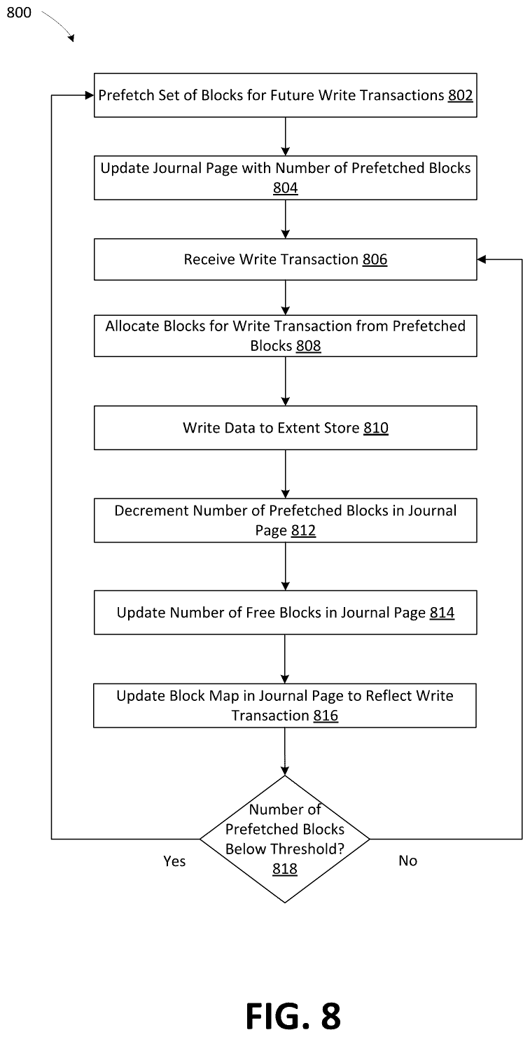

FIG. 8 is a flow diagram of method steps for operation of data management engine 210 utilizing the number of prefetched blocks field 408, number of free blocks field 410, and block map 412 from journal page 212, according to various embodiments. Although the method steps are described in conjunction with the systems of FIGS. 1-4, persons of ordinary skill in the art will understand that any system configured to perform the method steps, in any order, is within the scope of the invention.

As shown, a method 800 begins at step 802, where at startup, data management engine 210 prefetches blocks of storage from storage data 228 for allocation to write transactions. Data management engine 210 prefetches blocks from storage data 228 for subsequent write transactions to reduce the number of block allocations, which is computationally expensive. At step 804, data management engine 210 updates the journal page 212 with the number of prefetched blocks. Specifically, number of prefetched blocks field 408 is updated with the quantity of prefetched blocks so that data management engine 210 can prefetch additional blocks from extent store 207 when the quantity of prefetched blocks reduces below a configurable threshold due to write transactions performed by data management engine 210.

At step 806, data management engine 210 receives a write transaction 301. As noted above, a write transaction 301 can be received from or on behalf of a virtual machine storing data in a storage cluster or from another storage node operating as the primary storage node. At step 808, data management engine 210 allocates blocks for the write transaction from the prefetched blocks. At step 810, assuming data management engine 210 determines that the write transaction 301 is ready to be committed to extent store 207, data management engine 210 writes the data from the write transaction 301 to storage data 228 of the extent store 207. Once the data is written to the extent store 207, or to disk, the number of prefetched and free blocks has changed.

Accordingly, a step 812, data management engine 210 updates the number of free blocks field 410 to reflect the change in the number of free blocks caused by the write transaction 301. In some instances, the number of free blocks could decrease, remain constant, or increase depending upon the write transaction 301. At step 814, data management engine 210 updates number of prefetched blocks field 408 in journal page 212 to reflect the updated number of free blocks. At step 816, data management engine 210 updates the block map 412 to indicate which blocks within storage data 228 are free and which blocks are used to store data. In some embodiments, the block map 412 specifies an extent identifier or extent group identifier that is occupying the respective blocks.

At step 818, the data management engine 210 determines whether the number of prefetched blocks is below a configurable threshold. If the number of prefetched blocks is not below the threshold, method 800 returns to step 806, where the data management engine 210 processes subsequent write transactions 301. If the number of prefetched blocks is below the threshold, method 800 returns to step 802.

In sum, the disclosed techniques include storing a pending transaction record associated with a write operation in a pending transaction journal, wherein the pending transaction journal comprises a single block, such as a 4-kilobyte block that further includes all other pending transaction records associated with other write operations associated with the storage device. Depending upon whether a node in a storage cluster commits a transaction to the storage device, metadata associated with the transaction is stored in a metadata database, or a key value store, on the storage device. When the transaction is committed, the metadata is removed, or flushed, from the pending transaction journal. However, if the transaction is rolled back, the metadata is removed from the pending transaction journal.

At least one technical advantage of the disclosed techniques relative to prior art is that, with the disclosed techniques, a journal of the outstanding transactions, or tentative updates, on a storage device is captured in a single block. Further, a listing of tentative updates is maintained in the single block, which allows the system to keep the tentative updates small relative to using WALs. The disclosed techniques further allow the updating of the journal via an atomic read-modify-write operation of the single block, which avoids the drawbacks associated with more complex non-atomic operations when updating a conventional WAL. In addition, the disclosed techniques facilitate reduction of metadata format related transformations and eliminate checkpointing, further reducing overhead previously related to maintaining a WAL. The reduced journal size leads to reduced recovery time after a storage device crash, during which the journal is processed in order to restore the system after the crash. These technical advantages provide one or more technological improvements over prior art approaches.
1. In some embodiments, one or more non-transitory computer-readable media store program instructions that, when executed by one or more processors of a computing device, cause the one or more processors to perform a method comprising receiving a write operation directed to at least one data block in a first location on a storage device, storing write data associated with the write operation in a key-value store associated with the first location of the storage device, and storing a first pending transaction record associated with the write operation in a pending transaction journal, wherein the pending transaction journal comprises a single storage page that further includes all other pending transaction records associated with other write operations associated with the storage device.
2. The one or more non-transitory computer-readable media of clause 1, wherein the single storage page is equivalent in size to a size of a single block of the storage device.
3. The one or more non-transitory computer-readable media of clauses 1 or 2, wherein the single storage page is four kilobytes in size.
4. The one or more non-transitory computer-readable media of any of clauses 1-3, wherein the key-value store that includes the write data is stored separately from the pending transaction journal.
5. The one or more non-transitory computer-readable media of any of clauses 1-4, wherein the key-value store comprises a B-tree.
6. The one or more non-transitory computer-readable media of any of clauses 1-5, wherein the B-tree comprises a plurality of nodes, wherein each of the plurality of nodes comprises metadata for a respective location of the storage device.
7. The one or more non-transitory computer-readable media of any of clauses 1-6, wherein each of the plurality of nodes is stored in a respective single block of the storage device.
8. The one or more non-transitory computer-readable media of any of clauses 1-7, wherein the write operation stores data to the at least one data block.
9. The one or more non-transitory computer-readable media of any of clauses 1-8, wherein the first pending transaction record comprises an identifier of the first location of the storage device and a logical transaction sequence identifier.
10. The one or more non-transitory computer-readable media of any of clauses 1-9, wherein the method further comprises updating the first pending transaction record via an indivisible read-modify-write memory transaction.
11. The one or more non-transitory computer-readable media of any of clauses 1-10, wherein the method further comprises determining that the write operation is complete, and removing the first pending transaction record from the pending transaction journal.
12. The one or more non-transitory computer-readable media of any of clauses 1-11, wherein the method further comprises prefetching a plurality of data blocks associated with the storage device, storing, in the pending transaction journal, a number identifying how many data blocks were prefetched as a number of prefetched blocks, storing, in the pending transaction journal, the number identifying how many data blocks were prefetched as a number of free blocks, and storing, in the pending transaction journal, a set of block identifiers, wherein each data block identifier in the set of block identifiers identifies a different data block in the plurality of data blocks.
13. The one or more non-transitory computer-readable media of any of clauses 1-12, wherein the method further comprises assigning a first data block to the write operation, and decrementing a number of free blocks indicated by the single storage page.
14. The one or more non-transitory computer-readable media of any of clauses 1-13, wherein the method further comprises determining that the first data block should be overwritten, and incrementing the number of free blocks.
15. The one or more non-transitory computer-readable media of any of clauses 1-14, wherein the pending transaction journal stores a mapping of a logical address in at least one data block to a physical address in the first location of the storage device.
16. The one or more non-transitory computer-readable media of any of clauses 1-15, wherein pending transaction journal further comprises a map of free blocks of the storage device.
17. In some embodiments, a computer-implemented method comprises receiving a write operation directed to at least one data block in a first location on a storage device, storing write data associated with the write operation in a key-value store associated with the first location of the storage device, and storing a first pending transaction record associated with the write operation in a pending transaction journal, wherein the pending transaction journal comprises a single storage page that further includes all other pending transaction records associated with other write operations associated with the storage device.
18. The computer-implemented method of clause 17, wherein the single storage page is equivalent in size to a size of a single block of the storage device.
19. The computer-implemented method of clauses 17 or 18, wherein the single storage page is four kilobytes in size.
20. The computer-implemented method of any of clauses 17-19, wherein the key-value store that includes the write data is stored separately from the pending transaction journal.
21. The computer-implemented method of any of clauses 17-20, wherein the key-value store comprises a B-tree.
22. The computer-implemented method of any of clauses 17-21, wherein the B-tree comprises a plurality of nodes, wherein each of the plurality of nodes comprises metadata for a respective location of the storage device.
23. The computer-implemented method of any of clauses 17-22, wherein each of the plurality of nodes is stored in a respective single block of the storage device.
24. The computer-implemented method of any of clauses 17-23, wherein the write operation stores data to the at least one data block.
25. The computer-implemented method of any of clauses 17-24, wherein the first pending transaction record comprises an identifier of the first location of the storage device and a logical transaction sequence identifier.
26. The computer-implemented method of any of clauses 17-25, wherein the method further comprises updating the first pending transaction record via an indivisible read-modify-write memory transaction.
27. The computer-implemented method of any of clauses 17-26, wherein the method further comprises determining that the write operation is complete, and removing the first pending transaction record from the pending transaction journal.
28. The computer-implemented method of any of clauses 17-27, wherein the method further comprises prefetching a plurality of data blocks associated with the storage device, storing, in the pending transaction journal, a number identifying how many data blocks were prefetched as a number of prefetched blocks, storing, in the pending transaction journal, the number identifying how many data blocks were prefetched as a number of free blocks, and storing, in the pending transaction journal, a set of block identifiers, wherein each data block identifier in the set of block identifiers identifies a different data block in the plurality of data blocks.
29. The computer-implemented method of any of clauses 17-28, wherein the method further comprises assigning a first data block to the write operation, and decrementing a number of free blocks indicated by the single storage page.
30. The computer-implemented method of any of clauses 17-29, wherein the method further comprises determining that the first data block should be overwritten, and incrementing the number of free blocks.
31. The computer-implemented method of any of clauses 17-30, wherein the pending transaction journal stores a mapping of a logical address in at least one data block to a physical address in the first location of the storage device.
32. The computer-implemented method of any of clauses 17-31, wherein pending transaction journal further comprises a map of free blocks of the storage device.
33. In some embodiments, a first computing device comprises memory storing instructions, and one or more processors coupled to the memory and, when executing the instructions, are configured to perform operations comprising receiving a write operation directed to at least one data block in a first location on a storage device, storing write data associated with the write operation in a key-value store associated with the first location of the storage device, and storing a first pending transaction record associated with the write operation in a pending transaction journal, wherein the pending transaction journal comprises a single storage page that further includes all other pending transaction records associated with other write operations associated with the storage device.
34. The first computing device of clause 33, wherein the single storage page is equivalent in size to a size of a single block of the storage device.
35. The first computing device of clauses 33 or 34, wherein the single storage page is four kilobytes in size.
36. The first computing device of any of clauses 33-35, wherein the key-value store that includes the write data is stored separately from the pending transaction journal.
37. The first computing device of any of clauses 33-36, wherein the key-value store comprises a B-tree.
38. The first computing device of any of clauses 33-37, wherein the B-tree comprises a plurality of nodes, wherein each of the plurality of nodes comprises metadata for a respective location of the storage device.
39. The first computing device of any of clauses 33-38, wherein each of the plurality of nodes is stored in a respective single block of the storage device.
40. The first computing device of any of clauses 33-39, wherein the write operation stores data to the at least one data block.
41. The first computing device of any of clauses 33-40, wherein the first pending transaction record comprises an identifier of the first location of the storage device and a logical transaction sequence identifier.
42. The first computing device of any of clauses 33-41, wherein the operations further comprise updating the first pending transaction record via an indivisible read-modify-write memory transaction.
43. The first computing device of any of clauses 33-42, wherein the operations further comprise determining that the write operation is complete, and removing the first pending transaction record from the pending transaction journal.
44. The first computing device of any of clauses 33-43, wherein the operations further comprise prefetching a plurality of data blocks associated with the storage device, storing, in the pending transaction journal, a number identifying how many data blocks were prefetched as a number of prefetched blocks, storing, in the pending transaction journal, the number identifying how many data blocks were prefetched as a number of free blocks, and storing, in the pending transaction journal, a set of block identifiers, wherein each data block identifier in the set of block identifiers identifies a different data block in the plurality of data blocks.
45. The first computing device of any of clauses 33-44, wherein the operations further comprise assigning a first data block to the write operation, and decrementing a number of free blocks indicated by the single storage page.
46. The first computing device of any of clauses 33-45, wherein the operations further comprise determining that the first data block should be overwritten, and incrementing the number of free blocks.
47. The first computing device of any of clauses 33-46, wherein the pending transaction journal stores a mapping of a logical address in at least one data block to a physical address in the first location of the storage device.
48. The first computing device of any of clauses 33-47, wherein pending transaction journal further comprises a map of free blocks of the storage device.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. One or more non-transitory computer-readable media storing program instructions that, when executed by one or more processors of a computing device, cause the one or more processors to perform a method comprising:
receiving a write operation directed to at least one data block in a first location of a storage device;
storing write data associated with the write operation in a key-value store associated with the first location of the storage device; and
storing a first pending transaction record associated with the write operation in a pending transaction journal, wherein the pending transaction journal comprises a single storage page that further includes all other pending transaction records associated with other write operations associated with the storage device.

2. The one or more non-transitory computer-readable media of claim 1, wherein the single storage page is equivalent in size to a size of a single block of the storage device.

3. The one or more non-transitory computer-readable media of claim 1, wherein the single storage page is four kilobytes in size.

4. The one or more non-transitory computer-readable media of claim 1, wherein the key-value store that includes the write data is stored separately from the pending transaction journal.

5. The one or more non-transitory computer-readable media of claim 4, wherein the key-value store comprises a B-tree.

6. The one or more non-transitory computer-readable media of claim 5, wherein the B-tree comprises a plurality of nodes, wherein each of the plurality of nodes comprises metadata for a respective location of the storage device.

7. The one or more non-transitory computer-readable media of claim 6, wherein each of the plurality of nodes is stored in a respective single block of the storage device.

8. The one or more non-transitory computer-readable media of claim 1, wherein the write operation stores data to the at least one data block.

9. The one or more non-transitory computer-readable media of claim 1, wherein the first pending transaction record comprises an identifier of the first location of the storage device and a logical transaction sequence identifier.

10. The one or more non-transitory computer-readable media of claim 1, wherein the method further comprises:
updating the first pending transaction record via an indivisible read-modify-write memory transaction.

11. The one or more non-transitory computer-readable media of claim 1, wherein the method further comprises:
determining that the write operation is complete; and
removing the first pending transaction record from the pending transaction journal.

12. The one or more non-transitory computer-readable media of claim 1, wherein the method further comprises:
prefetching a plurality of data blocks associated with the storage device;
storing, in the pending transaction journal, a number identifying how many data blocks were prefetched as a number of prefetched blocks;
storing, in the pending transaction journal, the number identifying how many data blocks were prefetched as a number of free blocks; and
storing, in the pending transaction journal, a set of block identifiers, wherein each data block identifier in the set of block identifiers identifies a different data block in the plurality of data blocks.

13. The one or more non-transitory computer-readable media of claim 1, wherein the method further comprises:
assigning a first data block to the write operation; and
decrementing a number of free blocks indicated by the single storage page.

14. The one or more non-transitory computer-readable media of claim 13, wherein the method further comprises:
determining that the first data block should be overwritten; and
incrementing the number of free blocks.

15. The one or more non-transitory computer-readable media of claim 1, wherein the pending transaction journal stores a mapping of a logical address in at least one data block to a physical address in the first location of the storage device.

16. The one or more non-transitory computer-readable media of claim 1, wherein pending transaction journal further comprises a map of free blocks of the storage device.

17. A computer-implemented method, comprising:
receiving a write operation directed to at least one data block in a first location on a storage device;
storing write data associated with the write operation in a key-value store associated with the first location of the storage device; and
storing a first pending transaction record associated with the write operation in a pending transaction journal, wherein the pending transaction journal comprises a single storage page that further includes all other pending transaction records associated with other write operations associated with the storage device.

18. The computer-implemented method of claim 17, wherein the single storage page is equivalent in size to a size of a single block of the storage device.

19. The computer-implemented method of claim 17, wherein the single storage page is four kilobytes in size.

20. The computer-implemented method of claim 17, wherein the key-value store that includes the write data is stored separately from the pending transaction journal.

21. The computer-implemented method of claim 20, wherein the key-value store comprises a B-tree.

22. The computer-implemented method of claim 21, wherein the B-tree comprises a plurality of nodes, wherein each of the plurality of nodes comprises metadata for a respective location of the storage device.

23. The computer-implemented method of claim 22, wherein each of the plurality of nodes is stored in a respective single block of the storage device.

24. The computer-implemented method of claim 17, wherein the write operation stores data to the at least one data block.

25. The computer-implemented method of claim 17, wherein the first pending transaction record comprises an identifier of the first location of the storage device and a logical transaction sequence identifier.

26. The computer-implemented method of claim 17, wherein the method further comprises:
updating the first pending transaction record via an indivisible read-modify-write memory transaction.

27. The computer-implemented method of claim 17, wherein the method further comprises:
determining that the write operation is complete; and
removing the first pending transaction record from the pending transaction journal.

28. The computer-implemented method of claim 17, wherein the method further comprises:
prefetching a plurality of data blocks associated with the storage device;
storing, in the pending transaction journal, a number identifying how many data blocks were prefetched as a number of prefetched blocks;
storing, in the pending transaction journal, the number identifying how many data blocks were prefetched as a number of free blocks; and
storing, in the pending transaction journal, a set of block identifiers, wherein each data block identifier in the set of block identifiers identifies a different data block in the plurality of data blocks.

29. The computer-implemented method of claim 17, wherein the method further comprises:
assigning a first data block to the write operation; and
decrementing a number of free blocks indicated by the single storage page.

30. The computer-implemented method of claim 29, wherein the method further comprises:
determining that the first data block should be overwritten; and
incrementing the number of free blocks.

31. The computer-implemented method of claim 17, wherein the pending transaction journal stores a mapping of a logical address in at least one data block to a physical address in the first location of the storage device.

32. The computer-implemented method of claim 17, wherein pending transaction journal further comprises a map of free blocks of the storage device.

33. A first computing device comprising:
memory storing instructions; and
one or more processors coupled to the memory and, when executing the instructions, are configured to perform operations comprising:
receiving a write operation directed to at least one data block in a first location on a storage device;
storing write data associated with the write operation in a key-value store associated with the first location of the storage device; and
storing a first pending transaction record associated with the write operation in a pending transaction journal, wherein the pending transaction journal comprises a single storage page that further includes all other pending transaction records associated with other write operations associated with the storage device.

34. The first computing device of claim 33, wherein the single storage page is equivalent in size to a size of a single block of the storage device.

35. The first computing device of claim 33, wherein the single storage page is four kilobytes in size.

36. The first computing device of claim 33, wherein the key-value store that includes the write data is stored separately from the pending transaction journal.

37. The first computing device of claim 36, wherein the key-value store comprises a B-tree.

38. The first computing device of claim 37, wherein the B-tree comprises a plurality of nodes, wherein each of the plurality of nodes comprises metadata for a respective location of the storage device.

39. The first computing device of claim 38, wherein each of the plurality of nodes is stored in a respective single block of the storage device.

40. The first computing device of claim 33, wherein the write operation stores data to the at least one data block.

41. The first computing device of claim 33, wherein the first pending transaction record comprises an identifier of the first location of the storage device and a logical transaction sequence identifier.

42. The first computing device of claim 33, wherein the operations further comprise:
updating the first pending transaction record via an indivisible read-modify-write memory transaction.

43. The first computing device of claim 33, wherein the operations further comprise:
determining that the write operation is complete; and
removing the first pending transaction record from the pending transaction journal.

44. The first computing device of claim 33, wherein the operations further comprise:
prefetching a plurality of data blocks associated with the storage device;
storing, in the pending transaction journal, a number identifying how many data blocks were prefetched as a number of prefetched blocks;
storing, in the pending transaction journal, the number identifying how many data blocks were prefetched as a number of free blocks; and
storing, in the pending transaction journal, a set of block identifiers, wherein each data block identifier in the set of block identifiers identifies a different data block in the plurality of data blocks.

45. The first computing device of claim 33, wherein the operations further comprise:
assigning a first data block to the write operation; and
decrementing a number of free blocks indicated by the single storage page.

46. The first computing device of claim 45, wherein the operations further comprise:
determining that the first data block should be overwritten; and
incrementing the number of free blocks.

47. The first computing device of claim 33, wherein the pending transaction journal stores a mapping of a logical address in at least one data block to a physical address in the first location of the storage device.

48. The first computing device of claim 33, wherein pending transaction journal further comprises a map of free blocks of the storage device.
